(19) United States
(12) Patent Application Publication
(10) Pub. No.: US 2015/0236927 A1
(43) Pub. Date: Aug. 20, 2015

(54) UNIFIED COMMUNICATION SERVICE DEPLOYMENT SYSTEM

(71) Applicant: Unify Square, Inc., Bellevue, WA (US)

(72) Inventors: Eric Langer, Erftstadt (DE); Jochen Kunert, Bonn (DE)

(73) Assignee: Unify Square, Inc., Bellevue, WA (US)

(21) Appl. No.: 14/624,282

(22) Filed: Feb. 17, 2015

Related U.S. Application Data
(60) Provisional application No. 61/940,722, filed on Feb. 17, 2014.

(51) Int. Cl. H04L 12/24; H04L 29/08

(52) U.S. Cl. CPC H04L 41/5054; H04L 67/10; H04L 41/22

(57) ABSTRACT

A computer system creates a plurality of objects with associated tasks to be executed in a voice or video service deployment, and automatically controls at least part of the workflow associated with the tasks in the voice or video service deployment. The tasks may include survey tasks that involve gathering information such as country information, cabling information, site information, environment information, protocol information, network configuration information, private automatic branch exchange (PABX) system information. The tasks also may include design tasks, which may be based on information gathered via the survey tasks. The computer system also may associate messages (e.g., e-mails with relevant structured text and/or a task identifier) with at least one of the objects. The computer system also may automatically generate notifications in response to a change in workflow status of at least one of the objects.

### CROSS-REFERENCE TO RELATED APPLICATION

This application claims the benefit of U.S. Provisional Patent Application No. 61/940,722, filed on Feb. 17, 2014, the disclosure of which is hereby incorporated by reference in its entirety.

### BACKGROUND

The deployment of voice, video, and other unified communication (UC) services is complex. In a typical deployment, many serial and parallel tasks are needed to change an existing environment to a new platform, or to establish a new communication solution within a company and/or data network. Significant challenges often arise when dealing with existing private branch exchange (PBX) phone systems, which are typically locally deployed, disjoint systems. Individual sites within an organization are able to purchase and implement their own PBX systems, and little attention is paid to global design concepts that might allow these individual systems to be integrated within the organization.

In large deployments, task and project management is typically reliant on general-purpose tools such as spreadsheet applications or project management applications. Such tools do not easily accommodate workflows specific to UC service deployments, such as voice or video service deployments. Document management may be absent or loosely controlled, with project members using different file spaces. Customers may have to prepare templates for gathering required information, which may require a lot of time and technical know-how about the different network components (voice systems, LAN/WAN, IT environment, cabling, etc.). Multiple inputs of basic data may be required. Further, accurate documentation is often not available to guide new UC service deployments.

All of these issues require a large amount of resources to resolve during deployment, and analysis of completeness and technical correctness is correspondingly time-consuming and complex.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a computer system creates a plurality of objects with associated tasks to be executed in a voice or video service deployment, and automatically controls at least part of the workflow associated with the tasks in the service deployment. The tasks may include survey tasks that involve gathering information such as country information, cabling information, site information, environment information, protocol information, network configuration information, private automatic branch exchange (PABX) system information. The tasks also may include design tasks, which may be based on information gathered via the survey tasks. The computer system also may associate messages (e.g., e-mails with relevant structured text and/or a task identifier) with at least one of the objects. The computer system also may automatically generate notifications in response to a change in workflow status of at least one of the objects.

In another aspect, a client computing device presents a user interface that provides access to an object (e.g., a survey object, a design object, etc.) having a workflow status in a voice or video service deployment, and receives input via the user interface that effects a change in the workflow status and thereby causes generation of an automated notification message (e.g., an e-mail message) associated with the object. The message may be directed to a responsible entity associated with the object, and may include a link to the object. The client computing device also may present in the user interface a workflow diagram comprising workflow information for the object.

In another aspect, a computer system obtains and stores object transformation information relating to a plurality of objects with associated tasks to be executed in a voice or video service deployment, automatically controls workflow associated with the tasks in the service deployment, and automatically associates messages related to the service deployment with one or more of the objects. The computer system also may generate reports or audit trails, which may be based at least in part on the object transformation information.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram depicting an illustrative computer system that includes a host system that implements a voice or video service deployment system (VSDS);

FIG. 2 is a flow chart diagram that illustrates functions that may be performed by a client device and a host system, respectively, for a voice or video service deployment;

FIG. 3 is a screenshot diagram of a form for a design object for a service deployment;

FIGS. 4-9 are screenshot diagrams of forms/interfaces for a task management center in a VSDS;

FIG. 10 is a screenshot diagram of a workflow interface for a survey for a service deployment;

FIG. 11 is a flow chart diagram that illustrates a workflow for a survey for a service deployment;

FIG. 12 is a flow chart diagram of deployment process for a service deployment;

FIGS. 13 and 14 are screenshot diagrams of illustrative automated notifications for a survey prepared by a VSDS provider;

FIG. 15 is a screenshot diagram depicting an illustrative questionnaire relating to cabling for a service deployment;

FIG. 16 is a screenshot diagram of a workflow interface for a site object in a service deployment;

FIG. 17 is a screenshot diagram of a workflow interface for an implementation center in a VSDS;

FIG. 18 is a block diagram that illustrates basic aspects of a computing device appropriate for use in accordance with embodiments of the present disclosure.

### DETAILED DESCRIPTION

The following description provides details of an illustrative voice or video service deployment system. It should be understood that, in accordance with principles described herein, other embodiments that vary from the system described are also possible.

In the following description, numerous specific details are set forth in order to provide a thorough understanding of illustrative embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein. The illustrative examples provided herein are not intended to be exhaustive or to limit the claimed subject matter to the precise forms disclosed.

In the following description, systems and processes for voice service deployments (which also may be referred to as “voice cutovers” or “voice deployments”) for unified communication (UC) systems are described. The described systems and processes also are generally applicable to deployments of other UC services, such as video services. Some of the processes described herein facilitate accurately capturing technical parameters that are significant in such deployments. The technical parameters can be captured along with dependencies for existing environments in advance of deployments of new services. The technical parameters (e.g., parameters relating to capacity, protocols, and geography) can be automatically validated for UC and telecommunication systems (e.g., at a logical and/or physical level).

As further described herein, intermediate steps can be defined that describe transformation of data and services. Progress of deployment milestones can be tracked in a managed workflow (e.g., to an end state for the project). Described systems and processes can be used for discovering (e.g., through surveys) hardware, configurations, and performance information; defining component requirements (e.g., through designs) based on findings and target parameters (e.g., capacity, integration dependencies, etc.); and automated deployment (e.g., of firmware, configurations, and management components).

### I. Illustrative Voice or Video Service Deployment System

In this section, an illustrative voice or video service deployment system (VSDS) is described. The illustrative VSDS uses structured, process-controlled tasks in logical steps. The illustrative VSDS described herein is only an example. Other service deployment systems can be developed with different features according to principles described herein.

The illustrative VSDS provides tools for automated data handling and workflow control supported by structured data gathering, appropriate design, and documentation. As used herein, the terms “automatic,” “automated,” “automatically,” and related forms indicate that at least part of the respective functionality is performed without the need for user control. The illustrative VSDS effectively handles challenges of large-scale deployments by providing features such as task management, workflow control, automated handling of incoming e-mails and associating with them with particular tasks or objects, and automated mechanisms for preparation of surveys, designs, implementation manuals, scripts, and the like. The illustrative VSDS allows precise data preparation and fast global implementation of voice and/or video services.

The VSDS can facilitate integration with other services and systems, such as UC services and systems described in U.S. patent application Ser. No. 14/179,476, entitled “Advanced Tools for Unified Communication Data Management and Analysis,” filed on Feb. 12, 2014; and U.S. patent application Ser. No. 14/______, filed concurrently herewith, which claims the benefit of U.S. Provisional Patent Application No. 61/940,748, entitled “Lifecycle Management and Provisioning System for Unified Communications,” filed on Feb. 17, 2014, the disclosures of which are incorporated herein by reference. Such integration may include schema, data relationships, and technical means to analyze and actively manage such systems at a logical and physical level.

The illustrative VSDS may be used for automated configuration of existing UC technology platforms such as Microsoft Lync®, Skype® for Business, or other existing or to-be-developed UC platforms, media gateways, PBX systems, IP endpoints, and network components. The VSDS helps to reduce deployment time and costs, compared with prior methods for deploying UC services. The illustrative VSDS is highly scalable and supports deployments from single sites up to projects with several hundred sites.

In at least one embodiment, the VSDS is a cloud-hosted system that is able to provide project members with on-line access to current information at any time. In such an embodiment, the VSDS is hosted and operated by a system provider within the system provider's data center environment including server platforms, network access, security options, and communication services. Alternatively, the VSDS can be implemented as a customer application for installation on customer-owned platforms in a customer's network and server environment. A customer application or hosted system may be configured to operate in combination with a suitable service-tracking platform such as Omnitracker, available from Omninet GmbH, and may employ underlying interfaces or gateways provided by such a platform, e.g., basic communication, Web, and database interfaces.

The VSDS can be implemented in a server environment such as one based on Microsoft Windows Server®, including standard services like a database server (e.g., a SQL server), file services, a Web server (e.g., Microsoft® Internet Information Server, with virtual machines supported), and standard LAN/WAN infrastructure including edge services and firewall technology for access of internal and external users via an intranet and the Internet, respectively, using standard security mechanisms. Access can be provided to users in a variety of ways, such as via desktop or notebook computers (for client installations) or mobile devices (e.g., smart phones or tablet computers), and via standard Web browsers or custom applications.

As described herein, a UC service deployment system provides a structured approach that can be used to capture existing information on each site within an organization and set up a global database for the organization to provide a foundation for the deployment and for ongoing UC system operations. In terms of data storage, the VSDS is similar to a configuration management database (CMDB), which is a data repository for information technology (IT) assets. A CMDB may hold a collection of IT asset records, as well as descriptions of relationships between such assets. The repository facilitates understanding how critical assets, such as information systems, are organized, including their dependencies, sources, and targets. However, ordinary CMDBs suffer from limitations in many areas, including data collection and making the collected data useful. The illustrative VSDS addresses such challenges, among many other benefits.

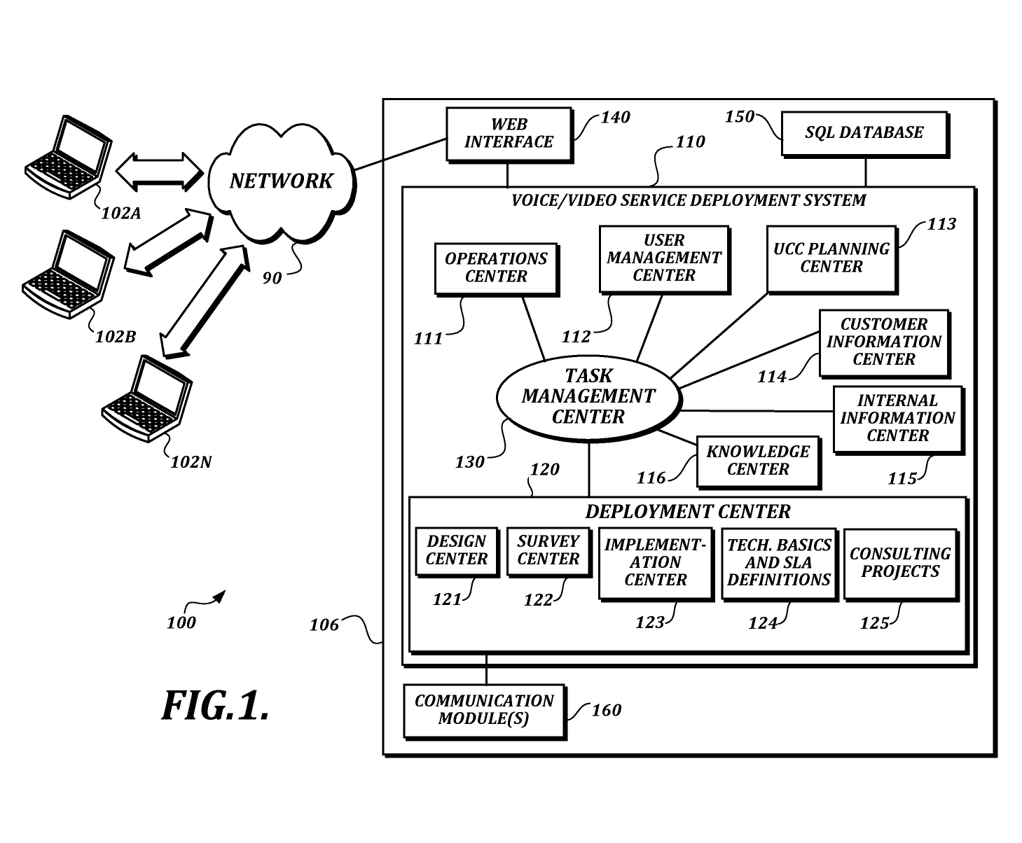

FIG. 1 is a block diagram depicting an illustrative computer system 100 that includes a host system 106 that implements a VSDS 110. In this example, the computer system 100 includes client computing devices 102A-N and the host system 106. The components of the system 100 may communicate with each other via a network 90. For example, the network 90 may comprise a wide-area network such as the Internet, a cellular network, or a combination of different types of wide-area networks. The network 90 may comprise one or more sub-networks (not shown). For example, the network 90 may include one or more local area networks (e.g., wired or wireless local area networks) that may, in turn, provide access to a wide-area network such as the Internet. The client devices 102A-N may be computing devices operated by end users of the VSDS 110

The host system 106 hosts the VSDS 110 on one or more servers and stores data in one or more data stores that include a SQL database 150 for storing voice and/or video service deployment data. Other data stores can store data and definitions that define elements to be displayed to an end user on a client device, such as a set of elements of a graphical user interface for interacting with the VSDS. Interface elements, such as text boxes, soft buttons, checkboxes, drop-down boxes, and/or the like, may receive input or present output (e.g., to an end user or system administrator). As shown, the host system 106 also provides a Web interface 140 that accepts input from and provides output to the client devices 102A-N via the network 90.

The host system 106 also provides one or more communication modules 160 that can be used to facilitate communications relating to the VSDS 110. For example, as described in detail below, the VSDS may provide tools for automated notifications (e.g., via e-mail), associating incoming or outgoing e-mails with particular tasks or objects, or the like. The communication modules 160 may include an e-mail system for e-mail messaging (e.g., an SMTP-based server supporting POP3/IMAP, such as a Microsoft® Exchange server). Other messaging systems (e.g., instant messaging (IM) systems) also may be used. Further details relating to e-mail communication and notifications are provided below.

In the example shown in FIG. 1, the VSDS 110 includes an Operations Center 111, a User Management Center 112, a UCC (Unified Communication and Collaboration) Planning Center 113, a Customer Information Center 114, an Internal Information Center 115, a Knowledge Center 116, a Deployment Center 120, and a Task Management Center 130. The Deployment Center 120 includes sub-modules such as a Design Center 121, a Survey Center 122 (for data gathering), an Implementation Center 123, a Technical Basics and SLA (Service Level Agreement) Definitions sub-module 124, and a Consulting Projects sub-module 125. The Task Management Center 130 coordinates tasks associated with the various modules and sub-modules of the VSDS 110.

Other arrangements are possible, within the scope of the present disclosure. For example, more or fewer modules, or different modules, may be included in the VSDS 110. As another example, modules other than the Deployment Center 120 may also contain sub-modules. In one embodiment, the UCC Planning Center 113 contains a Planning Survey sub-module and a High-Level Design module. This embodiment also serves to illustrate the concept that some categories of functionality (e.g., survey/data gathering and design) may be handled within the VSDS 110 by different modules, or by more than one module, depending on implementation.

In at least one embodiment, the VSDS 110 includes a template/form package to facilitate implementation of described features such as automated notifications, data collection, management of workflows, and the like. To illustrate, template and forms provided by the VSDS 110 may contain, for PCs (e.g., Windows or Web clients) or mobile devices, one or more of the following, which are described in further detail below:
templates for automated and manual notifications (e.g., object- or task-related e-mails, as described in further detail below);
templates with custom views, e.g., for different clients or based on context, such as workflow- or user-dependent views;
templates for exporting data (e.g., project-related data) to standard formats like XLS, CSV, database formats, or ASCII formats;
import templates (XLS, CSV, etc.) for automated import of off-line prepared data;
database design information;
report definitions; and
descriptive information for workflows, notifications, questionnaires, designs, reports, and project related manuals, including commonly used items such as generic material lists.

As mentioned above, the VSDS provides software objects (referred to herein as simply as “objects”) for project and task management. The specific features of individual objects vary depending on factors such as the service being deployed, the type of object, and the particular data contained within them.

A user interface, such as a fillable form, can be provided to allow modifications to be made to an object. Different types of objects may have different forms to allow modification of data specific that object type. The features of or information in a particular form also may depend on factors such as the current user or user group that is viewing the object, a workflow status associated with the object, and/or a blocking status associated with the object. A blocking status is used to ensure that once a value has been entered and confirmed for input to a subsequent step, the value can be relied upon and validated for correctness and/or consistency with other values. In at least one embodiment, a blocking status requires that a confirmed value cannot be changed without an official change request. Different forms or interfaces also may be provided for Windows clients, Web clients, and mobile devices.

In at least one embodiment, objects contain and/or implement one or more of the following:
fields for basic information, object identification, and SLA information;
workflow fields including the process and states associated with the object and commands for logical functions and automated notifications;
logical rules for processes;
links to other objects;
automated actions (e.g., mapping information for new objects, importing information from related objects);
data fields for selection of underlying information (e.g., from sub-objects or basic objects) from predefined lists as single objects or multiple objects (e.g., from a drop-down menu) to require precise decisions that improve upon inconsistent, free-from text descriptions;
buttons (or other user interface elements), which may be used, for example, to start actions manually following the workflow, or to get information from related objects;
views, filters, and search forms, which may be dependent on or independent of a current user or situation; and
fields for documentation times and history.

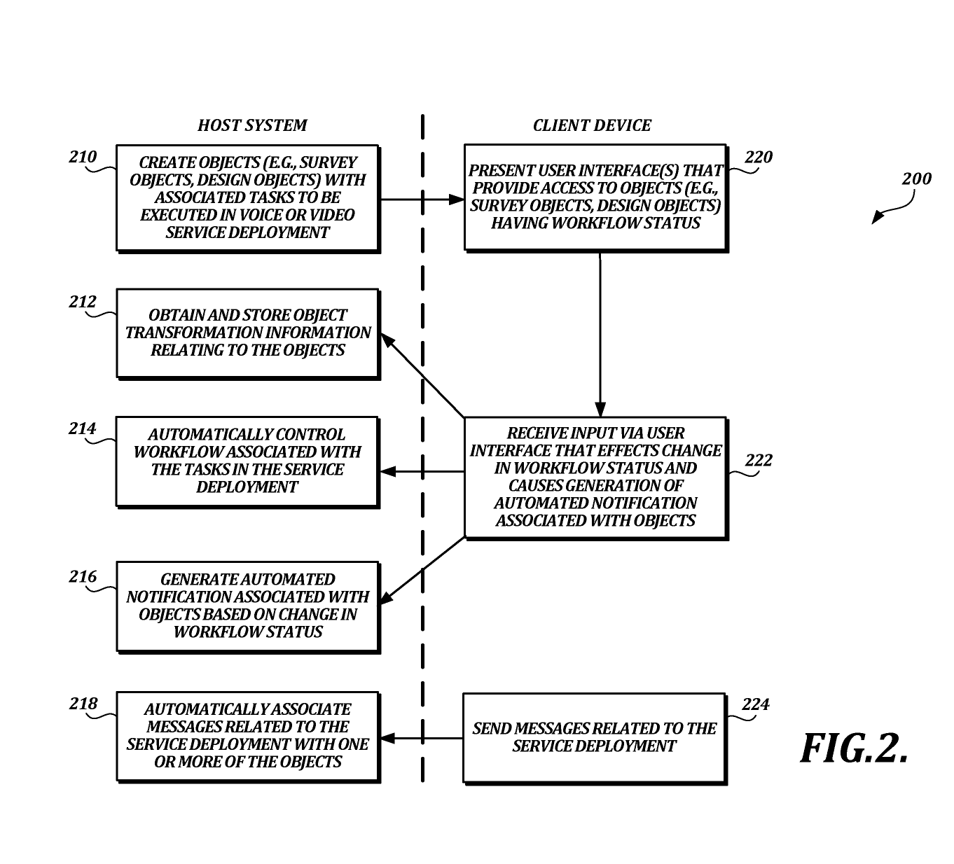

FIG. 2 is a flow chart diagram that illustrates functions that may be performed by a client device and a host system (e.g., host system 106) that hosts a VSDS (e.g., VSDS 110), respectively. In the example shown in FIG. 2, the host system performs functions such as creating objects (such as survey objects or design objects) with associated tasks that are to be executed in a voice or video service deployment (210), obtaining and storing object transformation information relating to the objects (212), automatically controlling at least part of the workflow associated with the tasks in the service deployment (214), generating automated notifications associated with objects based on changes in workflow status (216), and automatically associating messages relating to the service deployment with one or more of the objects (218). The client device performs functions such as presenting user interfaces that provide access to the objects (220), receiving input via the user interface that effects changes in workflow status and causes generation of automated notifications associated with the objects (222), and sending messages related to the service deployment (224). As shown, these functions are often interrelated. For example, the host system may perform functions 212, 214, and 216 in response to changes in the objects that may be initiated by the client device.

The functions depicted in FIG. 2 are only illustrative, as are the illustrated relationships between those functions. As will be clear from a reading of this disclosure, host systems and client devices may perform more functions, fewer functions, or different functions, and those functions may relate to each other in different ways.

Features of the illustrative VSDS and features of individual modules of the VSDS will now be described in detail.

Survey Objects

The VSDS system provides objects for data gathering. In at least one embodiment, survey objects are associated with structured questionnaires for gathering structured data relating to a voice and/or video service deployment. Questionnaires can be prepared with content, which may be created or selected via any suitable user interface elements, such as drop-down menus, check-boxes, text boxes, or the like. The basic structure of survey objects is predefined, but the VSDS system provides the ability to customize the structure and content of survey objects to fit with a particular service deployment. The content can be developed by a system provider. The fields can contain, e.g., technical content, commercial content, or other content. Survey objects are associated with specific survey tasks to be completed during execution of the survey.

Illustrative surveys are described in detail below.

Design Objects

The VSDS system provides design objects for service deployments. The basic structure of design objects is predefined, but the VSDS system provides the ability to customize the structure and content of design objects to fit with a particular service deployment. The structure and content can be developed by a system provider, and may be based on or supplemented with the system provider's own knowledge and experiences. Content may be created or selected via any suitable user interface elements, such as drop-down menus, check-boxes, text boxes, or the like. Design objects are associated with specific design tasks to be completed during execution of the design.

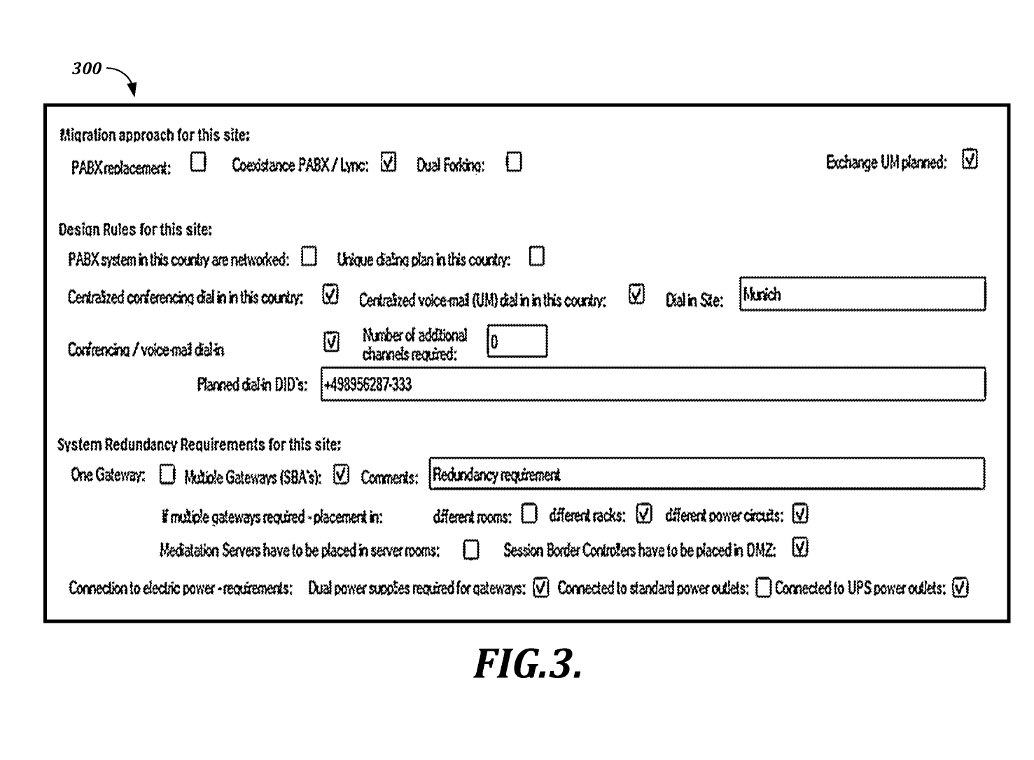

FIG. 3 is a screenshot diagram of a form 300 for a design object. The form 300 includes elements such as checkboxes and text boxes that allow a user to provide information about a design object for a particular site, such as a migration approach (e.g., whether the UC service being deployed will replace or coexist with a private automatic branch exchange (PABX) system), design rules (e.g., rules relating to conferencing call-in and voice mail), and system redundancy requirements (e.g., whether multiple gateways are required) for the site.

Illustrative design objects and design rules are described in further detail below.

System Navigation and User Interface

To aid in navigating the functions of the VSDS, navigation tools can be provided (e.g., in a user interface of a client device). In at least one embodiment, the VSDS system provides a shortcut bar with links to activate VSDS functionality, along with search functions and filters. In the shortcut bar, links can be organized by function or system component (e.g., by grouping links associated with a particular module such as the Deployment Center, the Customer Information Center, the Knowledge Center, or any other module of the VSDS). The shortcuts provided in the shortcut bar may allow a user to do one or more of the following:
go to a particular folder or object;
open help files (e.g., Web-based help pages); and
execute actions.

Navigation features, such as a shortcut bar, folder or object views, filters, and search options, can be predefined or customized based on factors such as a current user or user group, available user or administrative preferences, etc. As an example, a folder structure can be dependent on a current user or user group, with objects associated with other users or user groups being hidden.

E-Mail Integration

The VSDS system provides tools for managing project-related e-mail communication. Project related e-mails can be sent to a notification e-mail address and may contain structured text and a task identifier for automated assignment to an object. Structured text and task identifiers are helpful for automatically assigning e-mails to particular objects.

Outgoing e-mails can be created based on e-mail templates: a user can manually initiate creation of an e-mail by, for example, clicking a button within a form for an object and adding/editing the recipients list and the e-mail text. Object-related structured text and an object link can be part of the message template, to facilitate automated association with an appropriate object. Message templates can be customized for particular tasks, such as survey/data collection tasks. Automated notification e-mails can be generated based on workflow state changes or other events, such as an overdue task.

Incoming and outgoing e-mails can be associated with an object and can be made visible within the user interface for an object. E-mails can be associated with objects automatically based on structured text in the e-mail. In at least one embodiment, if an e-mail cannot be associated automatically with an object (e.g., if the e-mail does not contain structured text) the e-mail can be stored within a special folder. The system administrator or other responsible entity can manually assign the e-mails in the special folder (e.g., using a pull-down menu or other user interface element) to an object.

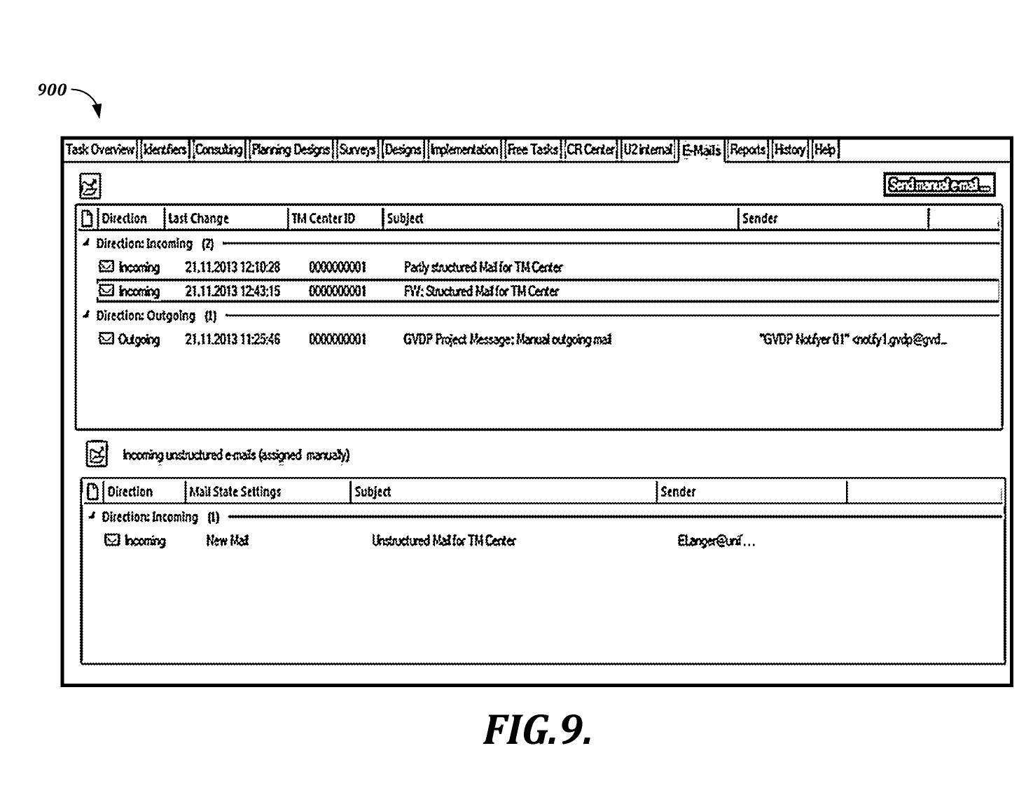

An illustrative interface for e-mail integration is described below with reference to FIG. 9.

Automated Actions

The VSDS system provides tools for automated actions. In at least one embodiment, available automated actions may include on or more of the following:
mapping of information to new objects if created from another object;
mapping of information with existing objects when a new object is created;
getting information from another object (e.g., per activation of a button);
automated calculations; and
workflow-related actions.

Automated actions can be used to automate processes, and can be used to prepare objects such as survey, design or implementation objects. Automated actions can be combined with scripts for additional functionality, e.g., for status changes or calculation operations. Some illustrative automated actions are described in further detail below.

Workflow Boxes

The VSDS system provides tools for workflow management. For example, workflow boxes are user interface elements that can be used to select states for a task that mirror a process in the deployment. The user can select allowed states and next steps for a task, such as whether a particular task has been confirmed by a project manager, and whether the task has been assigned to particular party, such as one of the system provider's consultants.

System Automation Interface

In at least one embodiment, the VSDS includes a system automation interface. This interface allows automated preparation of configuration files for import to element managers of the different active components that may have to be configured during implementation. Configuration files, can be prepared based on database content for, e.g., Microsoft Lync®, Skype® for Business, or other existing or to-be-developed UC platforms, PBX systems, gateways, deployment server, LAN components, etc. The output can be customized following a customer's specific requirements or environment.

The interface can use standard interfaces (e.g, an interface bus) of the Omnitracker platform, available from Omnitracker GmbH.

Specific modules of the illustrative VSDS 110 will now be described.

### A. Task Management Center

As explained above, the illustrative VSDS includes a Task Management Center. The Task Management Center is a module that is configured to control and manage relevant tasks for the service deployment process. The Task Management Center can be considered the entry point for a project.

A Task Management Center object can be created based on an existing project order. Creation of the Task Management Center object can be initiated by an authorized user, e.g., a project manager. The basic information for a project can be automatically imported to the Task Management Center. Within the Task Management Center, individual tasks of different types can be created, such as consulting tasks associated with consulting project objects, design tasks associated with design objects, survey (data collection) tasks associated with survey objects, implementation tasks, free defined tasks (to allow for customer specific workflows), operations tasks, product tasks, and support tasks.

A list of created tasks can be accessed via a user interface, as described in further detail below. Information such as the number of prepared objects, the number of objects with a particular status (e.g., ongoing or finished) can be viewed within the user interface. Task objects may contain one or more of the following elements:
task description and visibility options;
responsible persons, delegates, and reporting persons (e.g., for sending automated notifications);
workflow status (may include SLA times and dates);
references to related working objects in the Deployment Center (described in further detail below);
comments and related documents;
list of task-related incoming and outgoing e-mails; and
buttons or other user interface elements for creation of predefined reports.

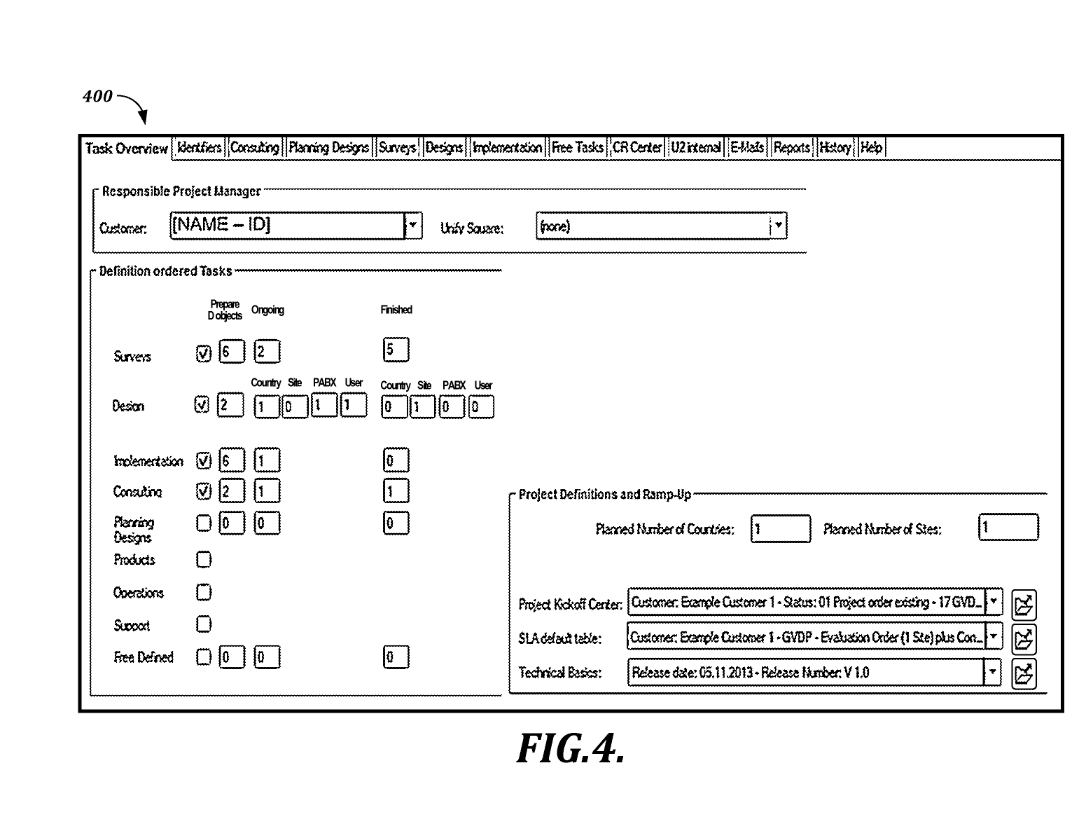

FIG. 4 is a screenshot diagram of a “Task Overview” form 400 in the Task Management Center. In the example shown in FIG. 4, the form 400 includes elements such as drop-down menus, checkboxes, and text boxes that allow a user to provide information about the project, such as responsible project managers, related tasks, project definitions, and the like.

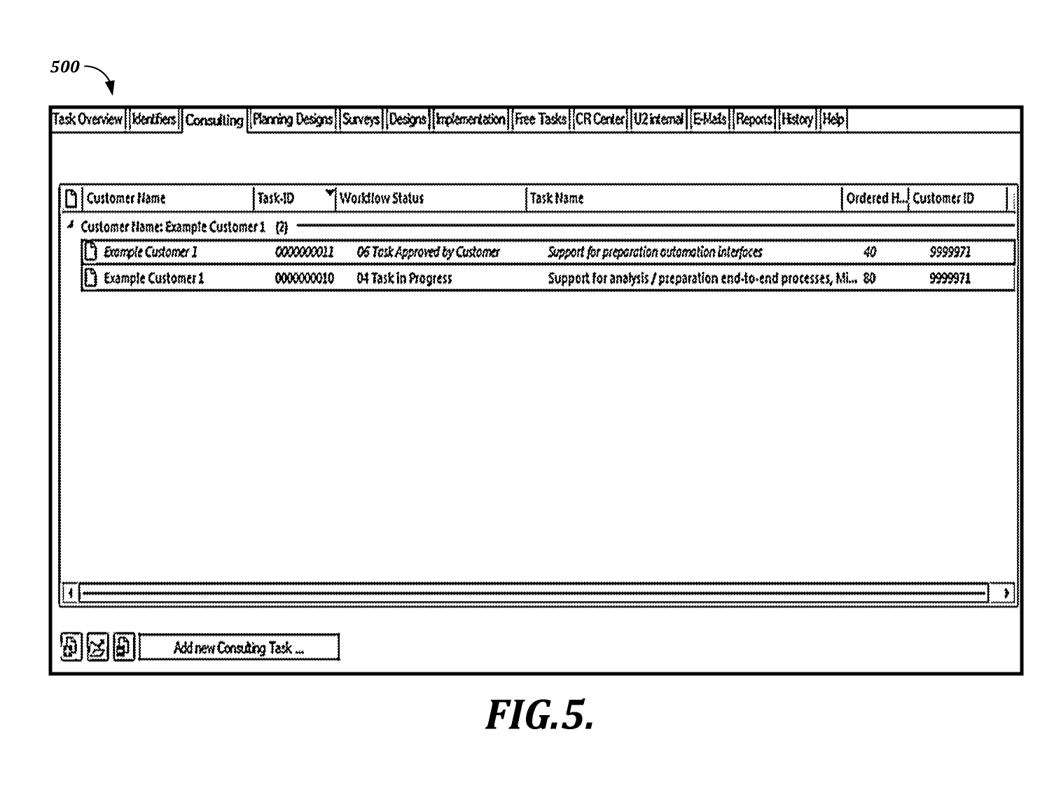

FIG. 5 is a screenshot diagram depicting a “Consulting” interface 500 in the Task Management Center. In the example shown in FIG. 5, the interface 500 includes a list of consulting tasks including information such as a customer name, task identifier (“Task ID”), workflow status, task name, and the like. A button labeled “Add New Consulting Task” is provided to allow a user to create new consulting tasks. Existing tasks also can be opened via this interface (e.g., by clicking on a task in the list).

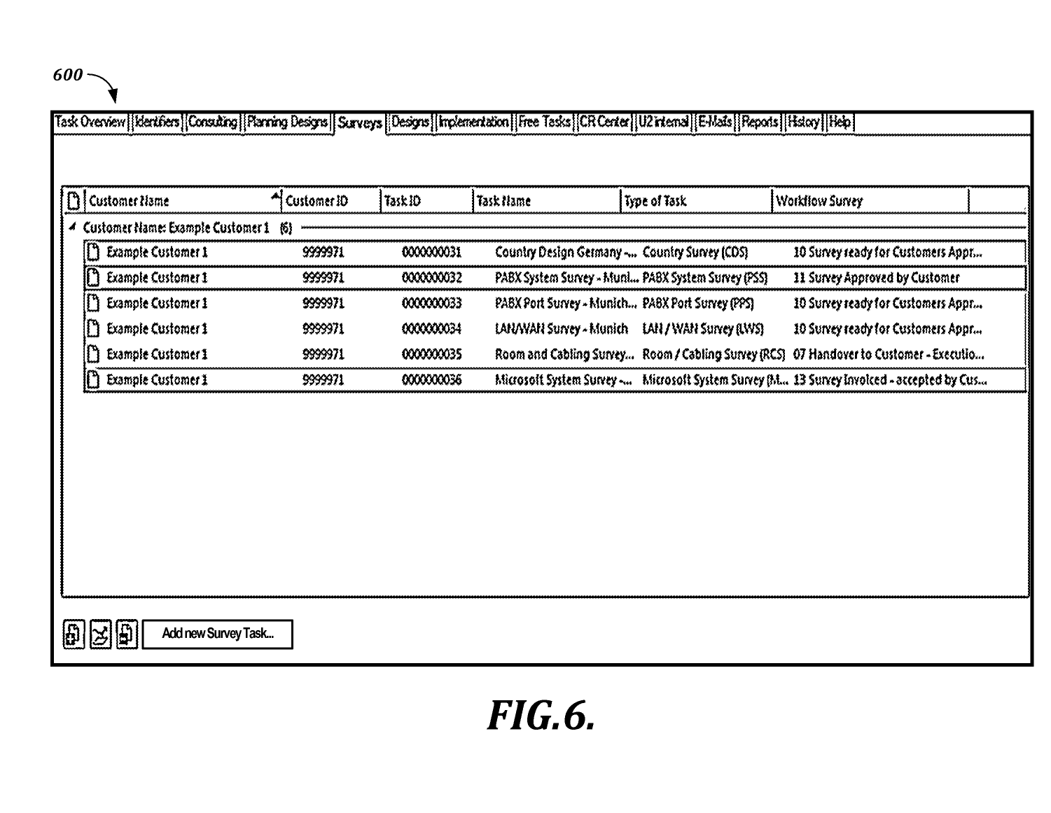

FIG. 6 is a screenshot diagram of a “Surveys” interface 600 in the Task Management Center. In the example shown in FIG. 6, the interface 600 includes a list of survey tasks including information such as a customer name, customer identifier (“Customer ID”), task identifier, task name, task type, and workflow status (e.g., ready for customer approval, approved by customer, invoiced, etc.). A button labeled “Add New Survey Task” is provided to allow a user to create new survey tasks. Existing tasks also can be opened via this interface (e.g., by clicking on a task in the list).

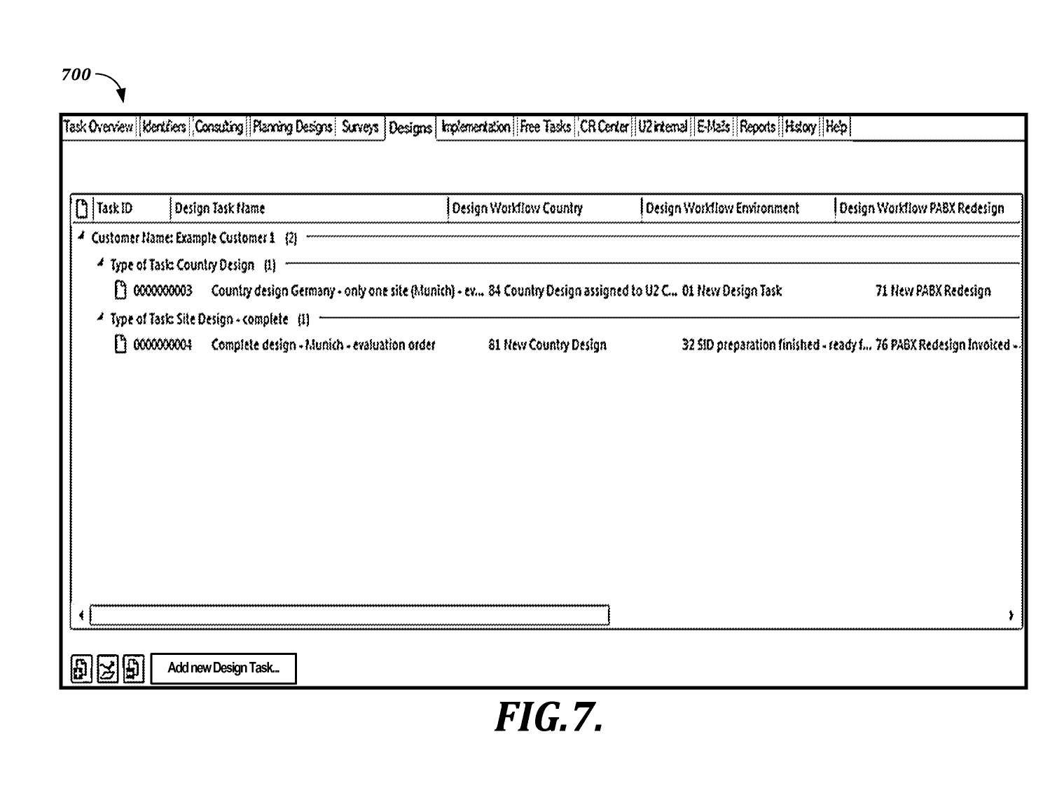

FIG. 7 is a screenshot diagram of a “Designs” interface 700 in the Task Management Center. In the example shown in FIG. 7, the interface 700 includes a list of design tasks including information such as a task identifier, task name, workflow status, and the like. A button labeled “Add New Design Task” is provided to allow a user to create new design tasks. Existing tasks also can be opened via this interface (e.g., by clicking on a task in the list).

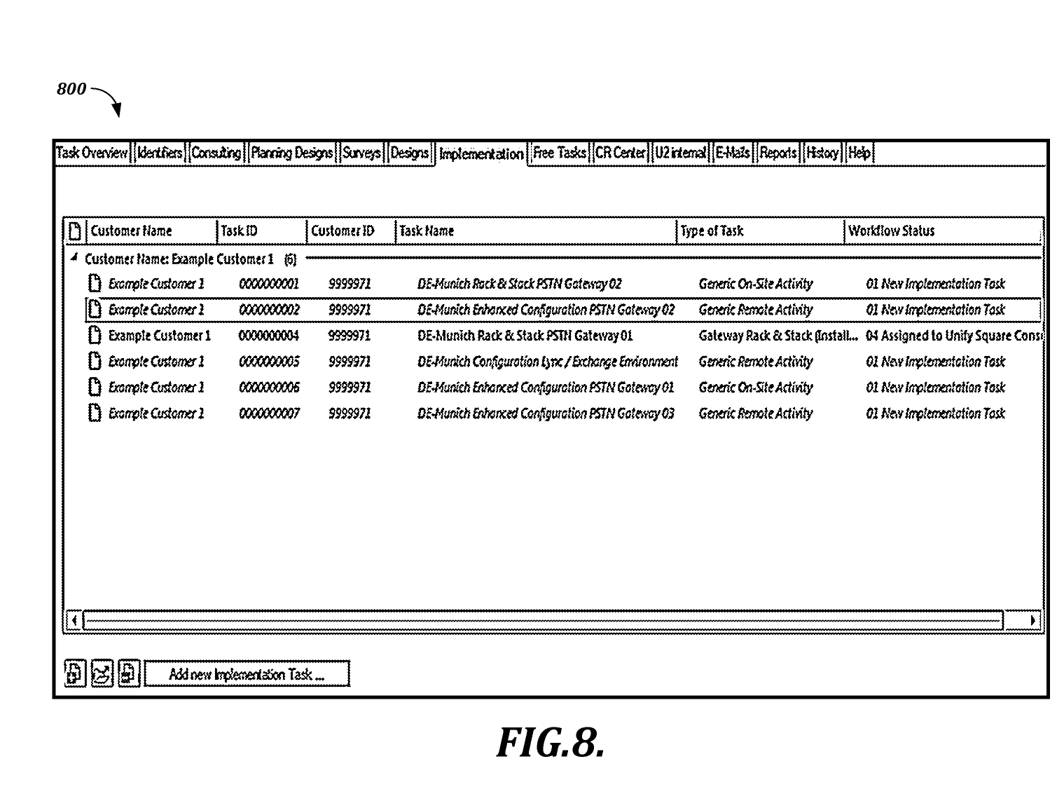

FIG. 8 is a screenshot diagram of an “Implementation” interface 800 in the Task Management Center. In the example shown in FIG. 8, the interface 800 includes a list of implementation tasks including information such as customer name, task identifier, customer identifier, task name, task type, and workflow status. A button labeled “Add New Implementation Task” is provided to allow a user to create new implementation tasks. Existing tasks also can be opened via this interface (e.g., by clicking on a task in the list).

FIG. 9 is a screenshot diagram of an “E-mails” interface 900 that provides e-mail integration for the Task Management Center. In the example shown in FIG. 9, the interface 900 includes a list of incoming and outgoing structured e-mails associated with a project, as well as a list of unstructured e-mails that can be assigned to a task manually. A button labeled “Send manual e-mail” is provided to allow a user to create new e-mails with structured text. Existing e-mails also can be opened via this interface (e.g., by clicking on an e-mail in one of the lists).

Tasks can follow a workflow with predefined status indicators. The status of a task can be revised by a program manager or a project member. Some status changes can lead to actions being initiated automatically, such as:
changes in field values (e.g., date of change);
automated notifications (e.g., that a task is ready for approval);
changes of object or field visibility or blocking status; and
changes in the state of forms presented in the user interface (e.g., information or options presented for a particular object may be dependent on workflow state.

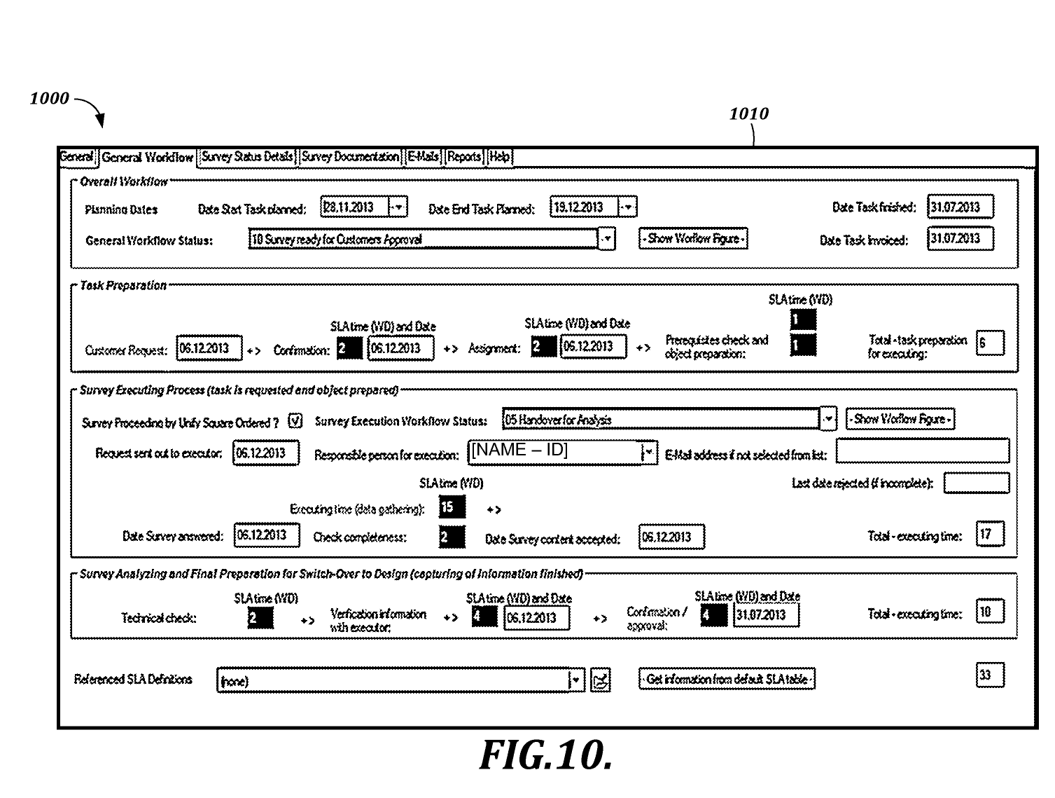

FIG. 10 is a screenshot diagram of a “General Workflow” interface 1000 that provides workflow information for a task. In the example shown in FIG. 10, the interface 1000 is associated with a survey task and includes elements such as drop-down menus and checkboxes that allow a user to provide information about the workflow for the task, such as planned start dates and end dates, task preparation information, survey execution status, responsible executors, survey analysis information, SLA definitions, and the like. The interface 1000 also provides information relating to responsibility for sub-tasks for the survey, such as preparing the survey object (for which the system provider is responsible), executing the survey (for which the customer is responsible), and checking completeness of the executed survey (for which the system provider or the customer may be responsible). Alternatively, responsibility for these sub-tasks may be distributed in some other way.

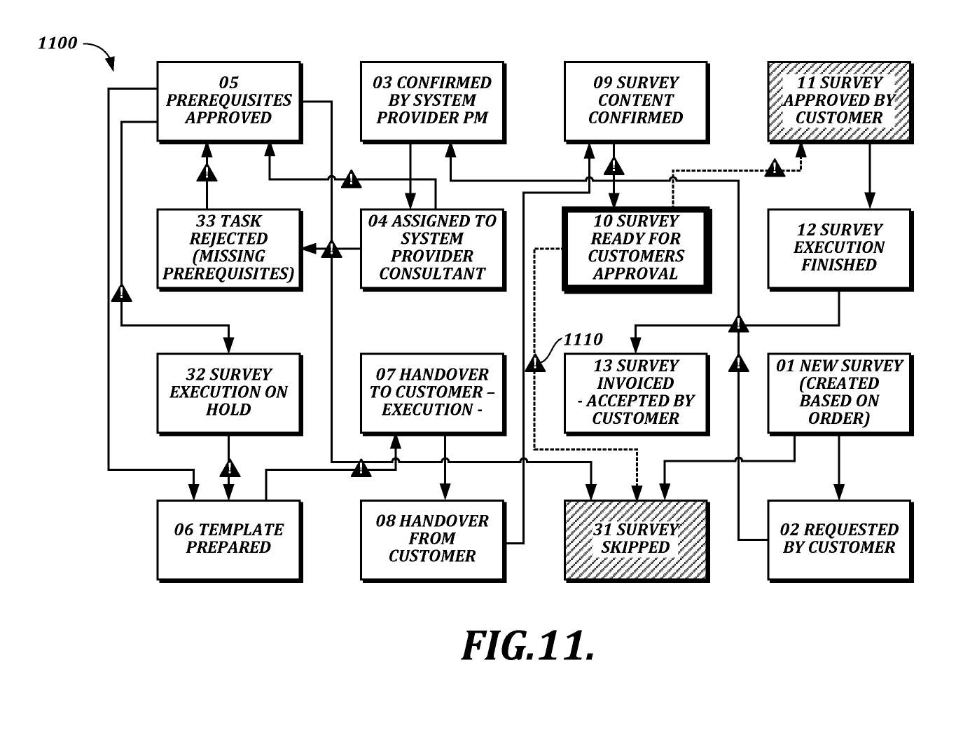

The interface 1000 also includes a button 1010 that can be activated to show a workflow figure corresponding to the task, such as the flow chart 1100 shown in FIG. 11. As shown in the flow chart 1100, the workflow need not be a strictly linear progression from one workflow status to the next. Instead, different workflows are possible for a particular task within the illustrated model. In the example shown in FIG. 11, the workflow for a survey task starts with creation of a new survey (status 01), which is requested by a customer (status 02) and confirmed by a system provider project manager (status 03). The task may be assigned to a system provider's consultant (status 04) which can determine whether prerequisites for the task are approved (status 05) or rejected (status 33). A rejected task can be revised and reevaluated, as needed. If the prerequisites are approved, a template is prepared (status 06). However, if survey execution is on hold (status 32), the preparation of the template may be postponed until the hold is removed.

After the template is prepared, the survey is handed over to the customer for execution (status 07) and then handed back to the system provider (status 08), which confirms the content of the survey (status 09). Once confirmed, the survey is ready for the customer's approval (status 10). If the survey is approved by the customer (status 11), survey execution is deemed to be finished (status 12) and the survey is invoiced (status 13). Invoicing the survey ends the workflow for the survey task.

Note that it is possible for the customer to elect to skip the survey (status 31) at different points in the workflow, e.g., after a new survey is created (status 01), after prerequisites are approved (status 05), or after survey content has been confirmed and submitted for customer approval (status 10). Skipping the survey ends the workflow for the survey task.

Referring again to FIG. 10, the interface 1000 indicates that the current general workflow status for this task is status 10 (“Survey ready for Customer's Approval”). As shown in FIG. 11, the current workflow status (status 10) is highlighted in the flowchart, as are the possible paths out of the highlighted status (e.g., to status 11 or status 31). This feature allows a user to quickly and clearly see, when the workflow figure is viewed in a user interface (e.g., via button 1010 in FIG. 10), the current state of the task. Information about a particular path from one status to another can be indicated by an icon 1110.

In at least one embodiment, a Kickoff Center module contains a structured, workflow-controlled process to initiate and control a new project, including project closing. In such an embodiment, the Task Management Center also can be used to create administrative tasks associated with the Kickoff Center.

Reports can be created for single objects or for multiple objects (including objects that may be been prepared from sub-objects). Reports may be predefined or customized. Predefined reports may include, for example, overview reports or detailed reports for task management objects and related tasks, and SLA (service level agreement) or KPI (key performance indicator) reports.

Change Request Center

The Change Request Center can be implemented as part of the Task Management Center to allow any project member to place change requests for project issues and task related issues. The change request can be created by a project member based on a form that allows characteristics of the change request to be specified, such as change request type, change request priority, identification of the requester, and any related documents or descriptions.

A change request manager or other responsible entity can be informed of new change requests by automated notification. The information provided in the change request form allows the change request manager to check the relevance of the change request and evaluate the correct person to execute the change request. The responsible entity and/or project/task references can be selected (e.g., via lists or drop-down menus). When ready, a notification can be sent to the responsible entity.

The responsible entity can analyze the change request and make decisions, including assigning a task as a minor change for realization, closing the change request (e.g., if not relevant), and/or assigning responsibility for the change or some aspect of the change to another entity, such as a program manager (e.g., for major changes) or a sales manager (e.g., for a change relating to sales).

Automated notifications can be sent regarding the workflow state of the change request. Tasks can be assigned depending on the assignment of the change. For example, if the program manager or sales manager is involved, the subsequent handling (e.g., preparing an offer or order, verifying that the content is project-related, closing the change request, finalizing the change request) can be assigned to the program manager or sales manager, respectively.

### B. Deployment Center

The illustrative VSDS system uses a deployment process that can be applied to roll-outs of services across multiple sites. As explained above with reference to FIG. 1, illustrative VSDS system includes a Deployment Center 120 with sub-modules such as a Design Center 121, a Survey Center 122 (for data gathering), an Implementation Center 123, a Technical Basics and SLA (Service Level Agreement) Definitions sub-module 124, and a Consulting Projects sub-module 125. This section describes an illustrative Deployment Center and its sub-modules in more detail.

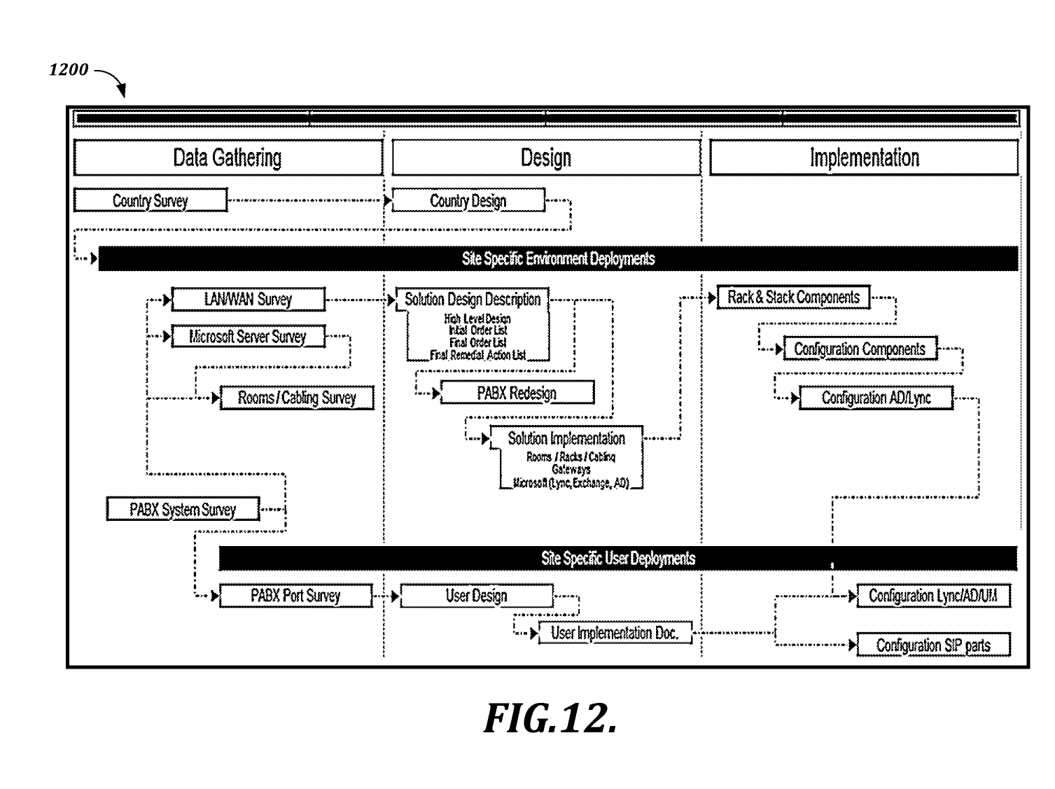

As shown in FIG. 12, a deployment process can be divided into data gathering, design, and implementation phases. These phases are described in further detail below, in the context of the relevant sub-modules.

Survey Center

The Survey Center facilitates data gathering. In the data gathering phase, information can be captured using surveys. In response to surveys, data can be obtained in different ways. In at least one embodiment, direct importation of information is supported (e.g., via database dumps, PABX system dumps, and/or data from meta-directories or an active directory, as is off-line capture of information based on templates (e.g., in CSV format); in this case, the returned template can be imported via a predefined database mechanism. Questionnaires can be used for on-line data capturing. Questionnaires can be prepared based on available information (e.g., from a customer's overall solution design and results of earlier questionnaires).

Referring again to FIG. 12, possible surveys to be executed in the data gathering phase include country surveys, LAN/WAN surveys, server surveys, rooms and cabling surveys, PABX system surveys, and PABX port surveys. Additional surveys also can be prepared and executed depending on factors such as a customer's specific requirements.

A country survey can be used to capture country-specific information such as legal and financial aspects, technical requirements, and responsible entities. All sites within a country can be listed with information such as address information, type of site, scope, dependencies of sites, existing voice or video equipment, integration in country networks or corporate networks, consolidation of circuits, dial-in access points, and the like. When all information is available, the country survey can be released and the system can be moved to a country design phase, as shown in FIG. 12. A released country design can provide basic information for later surveys.

A PABX system survey can capture information from an existing voice or video system or environment within a site. The questionnaire can contain technical questions about the installed system such as component locations, circuits, ports, endpoints, configured group and team functions, implemented special applications and servers, redundancy options, call routing, least cost routing, code digits, service numbers, etc. During site-specific preparation, information from country and site designs can be imported automatically and matched with overall design rules.

A LAN/WAN survey can capture relevant information from local and wide-area networks to supporting planning and implementation of the new design. The questionnaire can be predefined based on, for example, country design, overall design rules, and results from other surveys (e.g., a PABX system survey). Execution of the LAN/WAN survey can be a mix of capturing existing data and planning new UCC components.

A rooms and cabling survey can capture relevant information relating to location of existing components such as PABX systems and servers, network termination equipment, LAN switches, and information about existing cabling, such as PSTN circuits. The survey can be prepared based on PABX system survey information (e.g., via automated import) and basic rules for the design. Part of the execution also may involve planning the location and cabling of the new components. The executor has on-line access to the system and can select material from lists to describe the current situation and the planned design.

An environment survey (e.g., a Windows environment survey) can capture site-specific details in addition to global design rules. The questionnaire can be prepared based on global rules, country design, and results from other surveys, such as a PABX system survey.

A PABX port survey can cover detailed information per port or subscriber, based on existing information from a PABX or voice system. In at least one embodiment, the PABX port survey process include the following steps:
the survey is prepared based on a PABX system survey;
the executor enters the information per DID (direct inward dialing) extension number step-by-step (per object);
the executor gets a PABX database dump, which can be imported via an import script to the system database;
the incoming data is verified and analyzed;
the survey is approved by the customer/organization; and
the survey is released and made ready for following a user design.

The questionnaire for the PABX port survey, like other surveys, can contain structured questions (e.g., based on previously prepared pull-down menus or checkboxes). The executor can select possible options (e.g., per DID) or fill in text.

The executor of a survey can select predefined information such as planned new components and a generic or project-specific material list. Existing information like figures, floor plans, rack designs, etc., can be uploaded to an object (e.g., as an attachment) for the executor's information or as templates for completion.

When a questionnaire for a survey is prepared by a design team, the workflow status can be changed (e.g., via a drop-down menu) and a notification (e.g., e-mail) can be automatically sent to one or more responsible entities. The notification can contain a link to the prepared object; the executor can be automatically connected to the predefined object.

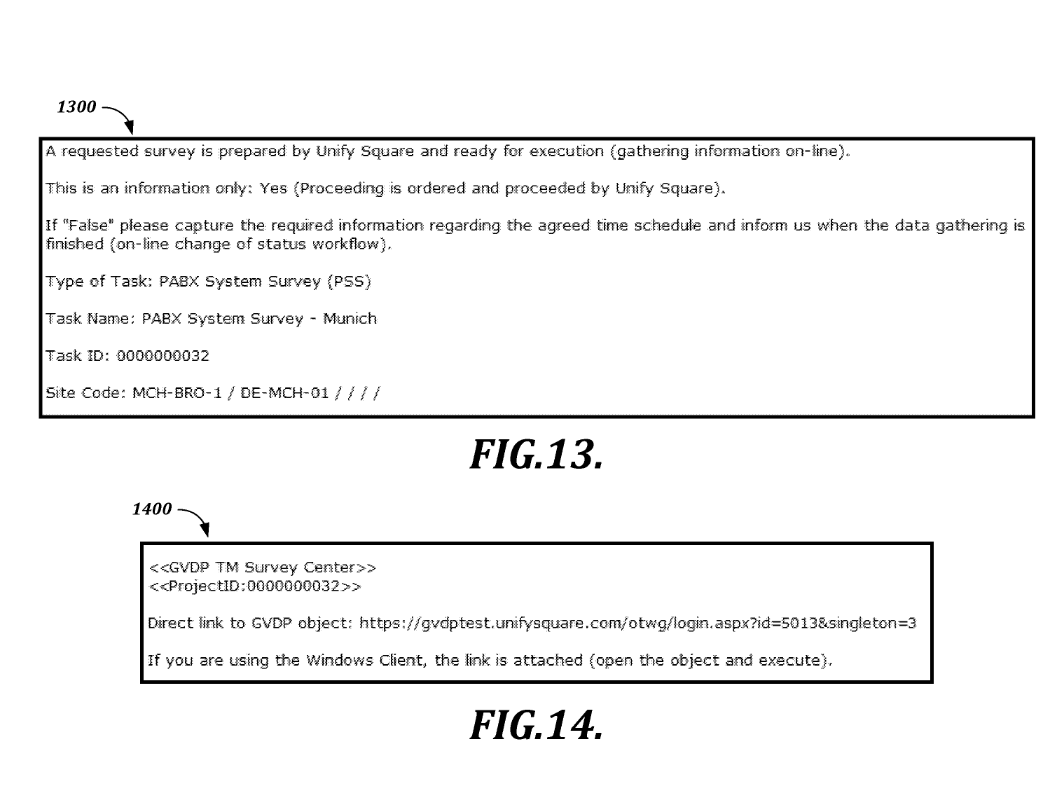

FIGS. 13 and 14 show illustrative automated notifications for a survey prepared by a system provider. Structured text for object identification can be included in the notifications. When the executor is sending a reply (e.g., via e-mail) the message can be automatically assigned to the object. The named executor can capture information by navigating to the object (e.g., via link or manual navigation) and answering questions (e.g., via drop-down menus, radio buttons, text boxes, or any other suitable user interface elements). The executor may also add figures, documents, photos, or other attachments to the object.

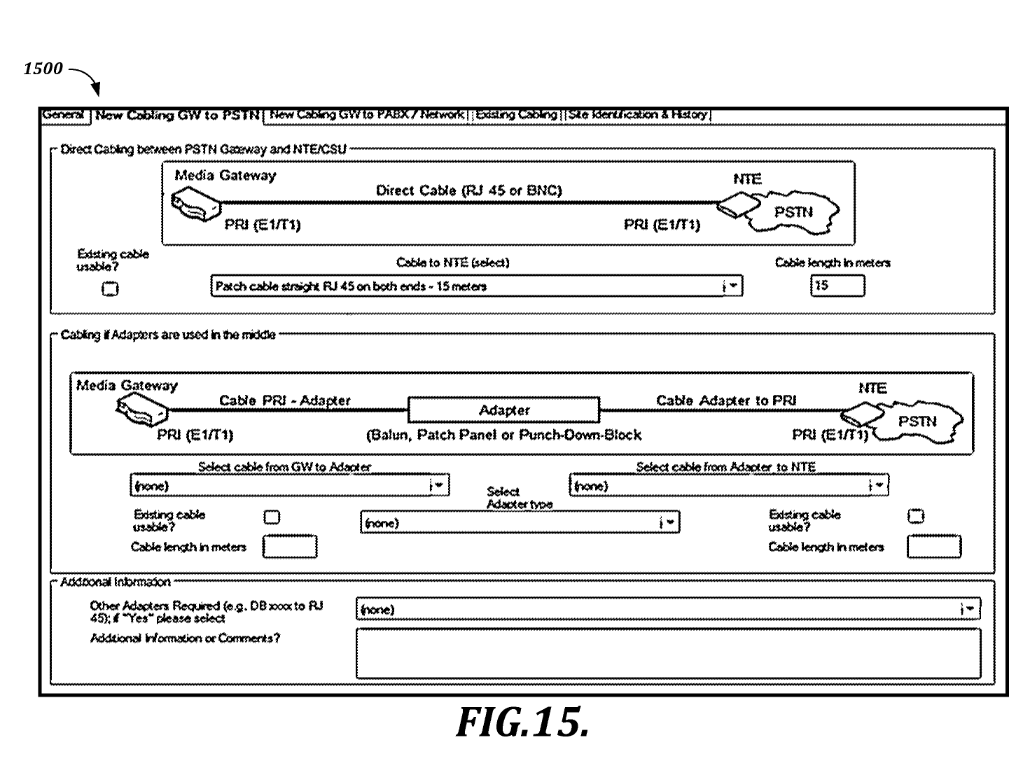

FIG. 15 is a screenshot diagram depicting an illustrative questionnaire 1500 relating to cabling. In the example shown in FIG. 15, the questionnaire 1500 includes elements such as drop-down menus, checkboxes, and text boxes that allow a user to provide information about a new cabling arrangement.

As explained above, the process of executing surveys can be controlled by the Task Management Center. The design team can check returned questionnaires for completeness and technical correctness. The survey can be approved by a customer or other responsible organization. The survey can be released and made ready for import to subsequent surveys or designs.

The executor can be given on-line access to the system via secure Internet connection and can save information at any time. When the capturing process is finished, the executor can send a structured e-mail to the design team or change the workflow. If the workflow is changed, an automated notification can be sent to a responsible party to inform them of the change. Project members also can be given access to survey information at any time via an on-line interface.

Design Center

The Design Center facilitates preparation of designs. In the design phase, designs are prepared based on basic design rules (e.g., from the Technical Basics/SLA Definitions module and results from surveys (e.g., from the Survey Center). Referring again to FIG. 12, the design phase may include country design, environment design, and user design.

Environment design relates to relevant active and passive components, including a redesign or planning of a new PABX or voice network. The design can be independent from user design. User design features may include, for example, phone number, endpoint, group and team definitions, access to special applications and services, UC platform (e.g., Microsoft Lync®, Skype® for Business, or other existing or to-be-developed UC platforms), and/or PABX configuration details.

A country design can be automatically prepared from a released country survey. The design engineer can map survey information with ground rules and additional information, such as diagrams. The design can be made available for viewing after release. Additional predefined reports can be created for overviews or details. A country object can contain:
country-wide design rules, legal information, and prerequisites;
a list of sites within the country, including site-specific details;
workflow states and release notes; and
additional information (files, documents, figures, etc.).

Via the user interface, a project member can create reports from single objects or multiple objects.

When a country design and site-specific surveys are released, the site specific design can be prepared (e.g., automatically or partly automatically) with imported data, design figures, and the like. Templates and supplementary information can be used to establish a framework for the designs. An object can be created that describes the site and may contain elements such as links, lists, or buttons for preparing and viewing the design details.

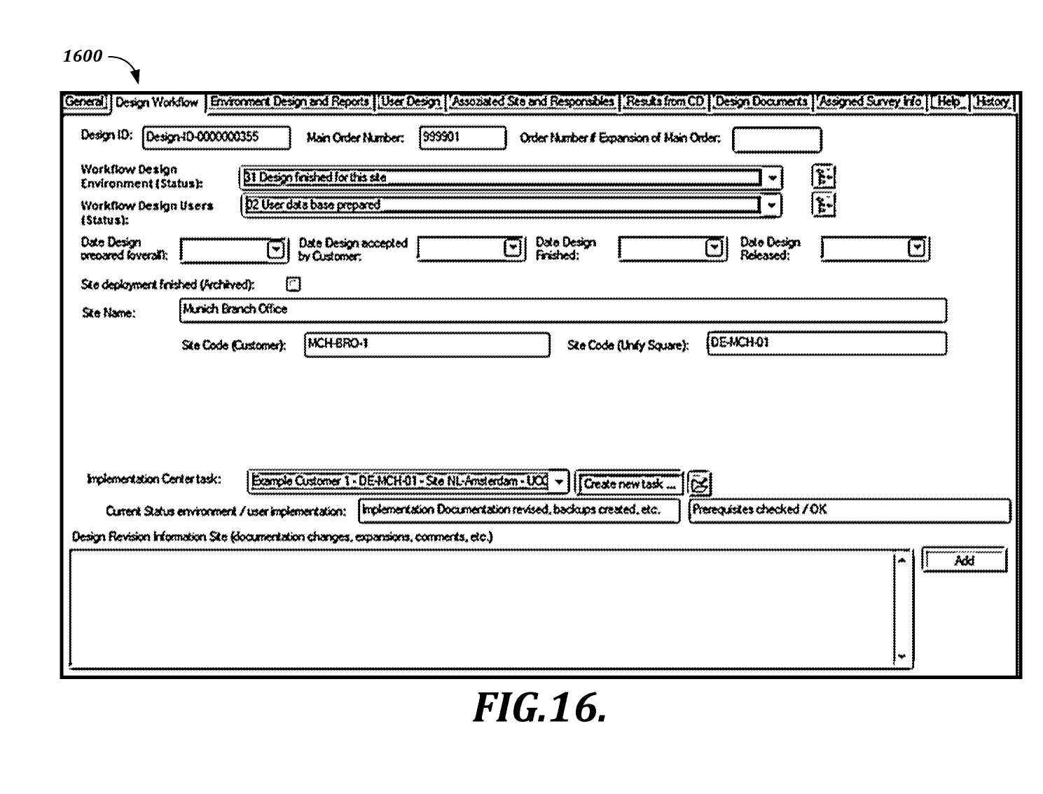

FIG. 16 is a screenshot diagram of a workflow interface for a site object. As shown in FIG. 16, site objects may be subject to more than one workflow, e.g., a workflow for environment aspects and a workflow for user-level aspects. In FIG. 16, separate drop-down boxes are shown for environment workflow status user-level workflow status.

The site-specific design process can proceed as follows:
High-level Design: The designer can create a new design object and import the existing information from sources such as surveys and Technical Basics. The output can be viewable (e.g., on-line) or can be exported (e.g., in a report). During an agreement process the design can be approved by a customer or responsible organization. In at least one embodiment, a high-level site-specific design contains:
   basic information from the site;
   a design summary;
   results from data gathering (information);
   planned new design;
   component design;
   descriptions of design, functionalities, special solutions, component location, etc.;
   site-specific functions (e.g., redundancy options, security options, etc.); and
   material list.
Detailed Design: When the High Level Design is approved, the designer can import technical details from released surveys and prepare a detailed design. In at least one embodiment, a detailed site-specific design contains a detailed technical description of the site including:
   location of components (e.g., within a building, room, or rack);
   electric power connection details;
   LAN cabling and IP configuration details;
   cabling of circuits;
   environment (e.g., Microsoft Lync®, Skype® for Business, or other existing or to-be-developed environments);
   PABX redesign or new PABX design; and
   figures supporting such above details.
Service Implementation Documentation: Based on a released detailed design, the site specific manuals for installing and configuration of the components can be prepared by automated import of design and survey data.
   The following information may be included in the documentation:
      instructions for component installation (e.g., rack and stack);
      instructions for component basic installation; and
      instructions for component configuration.
   A manual can be accessible in one or more of the following ways:
      on-line via a client device (computer, tablet, smart phone, etc.);
      as a report (database content can be exported to predefined reports for different business units or organizations; the output can be generic or component-specific);
      export to files or database following automated implementation; and
      export to implementation scripts.
   The documentation can be revised during implementation and made available for subsequent operations.
User Design: As part of a user design, a design database containing normalized data can be automatically generated based on surveys, such as a PABX port survey. Existing data can be mapped with additional information such as meta-directory or active directory data. Existing endpoints can be mapped to new endpoints based on defined rules.
   This database can be published for completion/revision of user-specific information by a customer or responsible organization. For example:
      The responsible person can log in to the system and revise any data record (e.g., a user object) on-line.
      An automated notification to users or user groups can be created. The user can revise the information on-line.
      Mixed executing group-based revision can be performed (e.g., by a cost center owner).
   When the user design is approved by customer or organization, the data can be made available for changes until a defined date for revision.
   The user interface can be closed for revisions and the implementation database can be created, which may include, e.g.:
      output for local installation (changing endpoints);
      scripts for configuration (e.g., Microsoft Lync® or Skype® for Business, PABX, etc.);
      ordering/providing endpoints; and
      implementation manuals per component group.

Technical Basics/SLA Definitions

The Technical Basics/SLA Definitions module provides basic information that can be used, for example, in the design phase or data gathering phase. Technical documents, descriptions, figures, etc., can be uploaded to other objects and made available for project members as an information pool. Important technical parameters and settings can be stored (e.g., as database objects) and later imported (e.g., automatically) to new survey objects and design objects. SLA definitions can be stored in this module. Defined rules and timelines can be imported to task objects for SLA and KPI reporting.

Implementation Center

The Implementation Center facilitates the implementation of designs and contains the objects for implementation of the components and user-related configurations. All site related tasks can be presented by the Implementation Center, including manuals created during the design phase. When a site object is created automatically, relevant information from the design can be mapped to the site object, such as site name, a reference to the site-specific design, and related tasks. Relevant instructions for implementing a system design can be presented by the Implementation Center and can be used on-line or off-line (e.g., via a report). Prepared configuration files (scripts) can be downloaded using the Implementation Center.

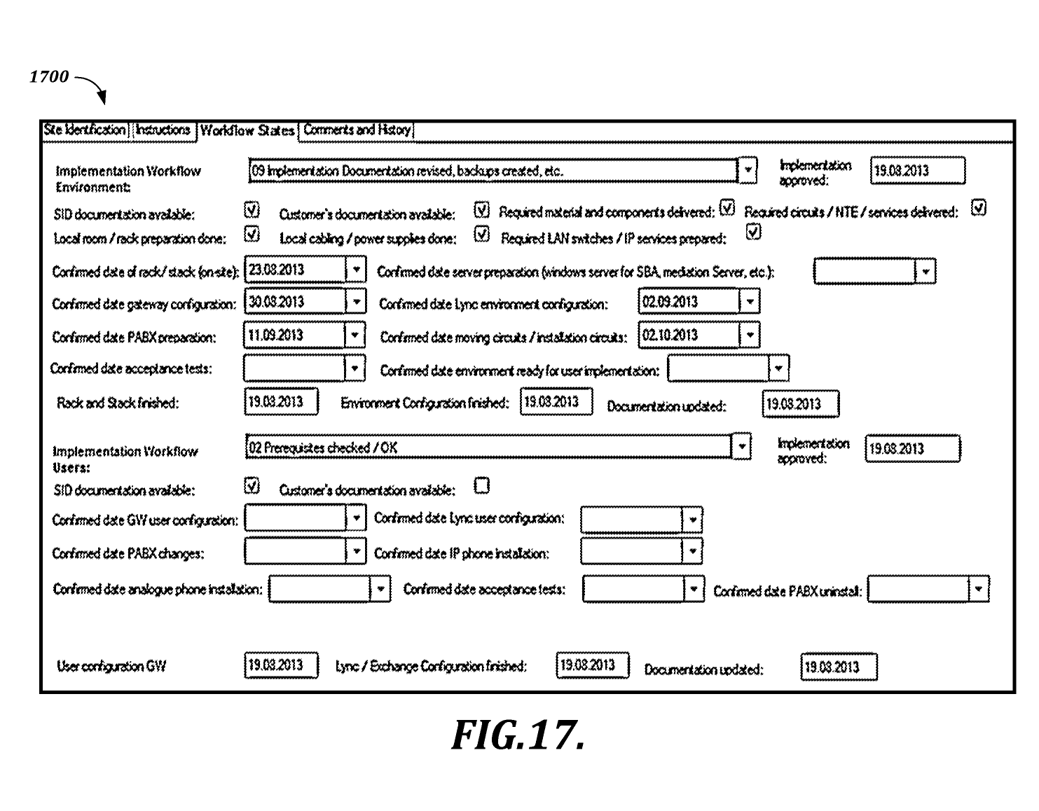

Like other modules described herein, the Implementation Center provides access to workflow information and facilitates workflow control. FIG. 17 is a screenshot diagram of a workflow interface for the Implementation Center. As shown in FIG. 17, an implementation may be subject to more than one workflow, e.g., a workflow for environment aspects of the implementation and a workflow for user-level aspects of the implementation. In FIG. 17, separate drop-down boxes are shown for environment workflow status user-level workflow status.

Consulting Projects

In at least one embodiment, the Consulting Projects sub-module contains working objects for support of consulting projects, which are controlled by the Task Management Center. The Consulting Projects sub-module supports consulting tasks with a predefined workflow process. Features of the Consulting Projects module may include general task information and creation of reports (e.g., by project member) containing the current status, general project information (e.g., time stamped comments or information, a list of task reports, etc.), project documents (e.g., input files, project documents, document history descriptions, etc.), and the like.

### C. UCC Planning Center

As explained above with reference to FIG. 1, the illustrative VSDS system 110 includes a UCC Planning Center 113. This section describes an illustrative UCC Planning Center in more detail.

The UCC Planning Center allows data gathering and high-level design for sites (locations) on a non-technical level for subsequent detailed planning and business case calculations. The results can be later imported (e.g., automatically) to a deployment process as an input for country or site designs.

In at least one embodiment, the UCC Planning Center contains two main sub-modules: UCC Planning Survey and UCC High-Level Designs. The UCC Planning Survey sub-module is prepared with existing information and other available basic design rules. When prepared, the survey can be published for subsequent on-line data capturing by an executor. Existing information such as diagrams, floor plans, rack designs, etc., can be uploaded to an object (e.g., as an attachment) for the executor's information or as templates for completion. Existing SLA definitions and basic information for a site can be imported from a database. Data gathering and related processes, such as preparation of survey objects and execution of surveys, can be performed using techniques described above.

A designer can prepare a high-level design based on survey results or other information from a customer or organization (e.g., if a survey was not executed). In at least one embodiment, a UCC high-level design describes the following items:
basic information from site (location);
a design summary;
an architecture description;
a functional description;
details from the existing voice system;
existing LAN/WAN environment and required changes/expansions;
existing software environment and required changes/expansions;
existing locations and required changes/expansions;
existing cabling and required changes/expansions; and
a list of required material, services, software, etc.

The customer can be given on-line access to the prepared survey and design for, e.g., preparation of subsequent documentation or calculating a business case.

### D. Operations Center

As explained above with reference to FIG. 1, the illustrative VSDS system 110 includes an Operations Center 111. This section describes an illustrative Operations Center in more detail.

When the deployment process of a site, country, or environment is finished, a customer can use the VSDS for operational tasks and maintenance. To facilitate this, the information relating to the finished deployment can be imported to an operations center. In at least one embodiment, this information includes environment details (e.g., active component configuration, location information, cabling, etc.) and user-level details (e.g., port/number/addressing details, related endpoint information, group functions, etc.)

The customer can be given access to this information for purposes such as address management (e.g., for a phone number database), operational tasks like IMACD (install, move, add, change, and disposal) operations, or user help desk (UHD) support. UHD support may provide access to any port, user, or phone number-related details and to environment documentation. IMACD operations may involve changes, expansions, or decommissioning of existing environment components or user-related services and endpoints, including export for subsequent execution (e.g., creation of notification e-mails, documents, or configuration files). The Operations Center also may provide an interface to a system provider's provisioning platform, as the platform described in U.S. Provisional Patent Application No. 61/940,748, entitled “Lifecycle Management and Provisioning System for Unified Communications,” filed on Feb. 17, 2014, the disclosure of which is incorporated herein by reference.

### E. Customer Information Center

As explained above with reference to FIG. 1, the illustrative VSDS system 110 includes a Customer Information Center 114. This section describes an illustrative Customer Information Center in more detail.

In a one usage scenario, the Customer Information Center is used by a system provider. Content can be selected from objects such as task management objects or working objects provided by the Deployment Center.

In at least one embodiment, the Customer Information Center includes the following:
Customer List: a list of customers with details such as addresses, responsible persons, contracting information, etc.
Order List: a list of all orders related to a customer. The information can be later used for reporting (e.g., SLA/KPI reporting) and selection within working objects (e.g., ordered material or hour rates). Any ordered material can be listed (e.g., by a main order). Expansions of existing orders are possible and can be assigned to a project.
Site List: a list of a customer's sites with basic information. The information can be selectable from working objects to avoid multiple entries of site information data.
Sub-customers, partners, and vendors list: The information can be selectable within working objects. The listed partners, in combination with a user account, may have access to objects (e.g., project-related or object-related).

### F. Internal Information Center

As explained above with reference to FIG. 1, the illustrative VSDS system 110 includes an Internal Information Center 115. This section describes an illustrative Internal Information Center in more detail.

In a one usage scenario, the Internal Information Center is used by a system provider. In at least one embodiment, the Internal Information Center includes the following:
Country Information: Here, all countries can be listed, including details for design and implementation. The objects can be selectable from working objects, but the content can be made only partly readable for project members.
Document Center: This folder can contain related documents for a project member's information or downloads of templates. The files can be stored within a database. The contained documents can be controlled by a workflow process.
Material and Services: This folder can contain all material selectable from an order object. For a system provider, this may include all available material, independent of specific customer needs. For a customer, this folder may contain the customer's own material list.

### G. Knowledge Center

As explained above with reference to FIG. 1, the illustrative VSDS system 110 includes a Knowledge Center 116. This section describes an illustrative Knowledge Center in more detail.

In a one usage scenario, the Knowledge Center contains a system provider's internal information. In at least one embodiment, the Knowledge Center includes the following:
Knowledge Base: This can contain information for designers or help desk members. A full-text search capability can be provided.
Technical Manual Center: Here, manuals or other files can be stored as a resource for design execution or implementation tasks. The documents can be stored in a database.
System Provider Locations: Here, the locations from a system provider can be listed. Within the user object the location can be selectable. The information can be used for assignment of people to working tasks.

### H. User Management Center

As explained above with reference to FIG. 1, the illustrative VSDS system 110 includes a User Management Center 112. This section describes user management functionality, which may be provided by an illustrative User Management Center, in more detail.

The VSDS system may have different categories of users. For example, some users may be associated with a system provider, while other users may be associated with a customer, partner, or vendor. As explained above, the particular features and information that are presented via user interfaces, such as access to particular folders and objects, may depend on a current user and/or the user's relationship to a particular group. For example, customers, partners, and vendors may have access to their own objects while system objects or objects from other groups are hidden. As another example, for objects that are associated with particular users or groups of users, automated notifications relating to those objects can be generated and sent to those users.

Features of the User Management Center can include a user interface for managing and selecting users for working objects. The User Management Center also may handle tasks relating to user authentication. User authentication can be realized in different ways, such as via a Lightweight Directory Access Protocol (LDAP) single sign-on mechanism or password authentication.

### II. Illustrative Devices and Operating Environments

Unless otherwise specified in the context of specific examples, described techniques and tools may be implemented by any suitable computing device.

Some of the functionality described herein may be implemented in the context of a client-server relationship. In this context, server devices may include suitable computing devices configured to provide information and/or services described herein. Server devices may include any suitable computing devices, such as dedicated server devices. Server functionality provided by server devices may, in some cases, be provided by software (e.g., virtualized computing instances or application objects) executing on a computing device that is not a dedicated server device. The term “client” can be used to refer to a computing device that obtains information and/or accesses services provided by a server over a communication link. However, the designation of a particular device as a client device does not necessarily require the presence of a server. At various times, a single device may act as a server, a client, or both a server and a client, depending on context and configuration. Actual physical locations of clients and servers are not necessarily important, but the locations can be described as “local” for a client and “remote” for a server to illustrate a common usage scenario in which a client is receiving information provided by a server at a remote location.

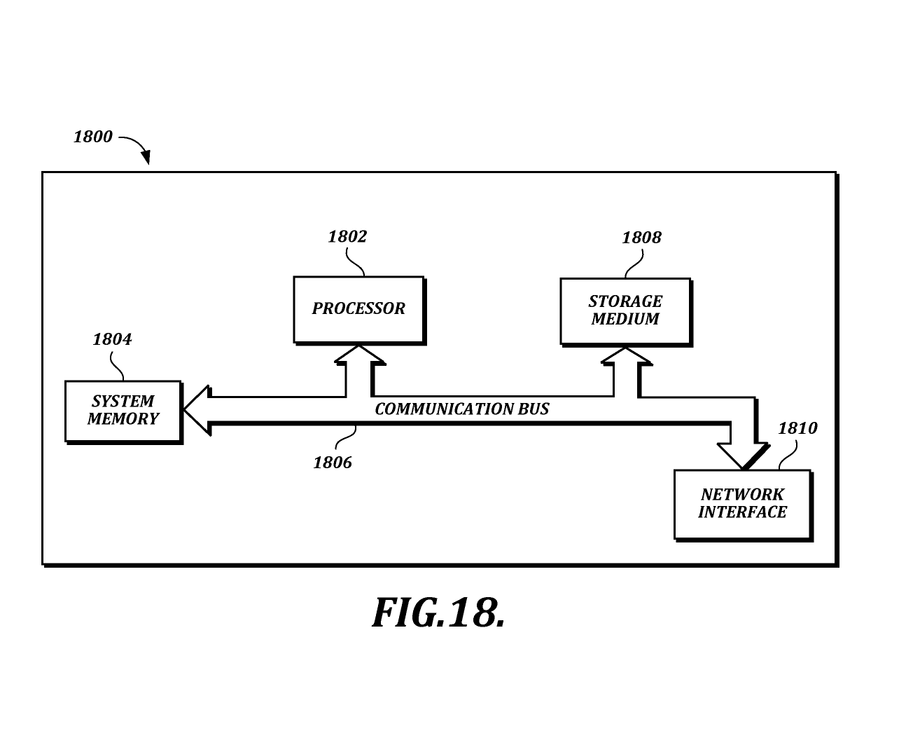

FIG. 18 is a block diagram that illustrates aspects of an illustrative computing device 1800 appropriate for use in accordance with embodiments of the present disclosure. The description below is applicable to servers, personal computers, mobile phones, smart phones, tablet computers, embedded computing devices, and other currently available or yet-to-be-developed devices that may be used in accordance with embodiments of the present disclosure.

In its most basic configuration, the computing device 1800 includes at least one processor 1802 and a system memory 1804 connected by a communication bus 1806. Depending on the exact configuration and type of device, the system memory 1804 may be volatile or nonvolatile memory, such as read only memory (“ROM”), random access memory (“RAM”), EEPROM, flash memory, or other memory technology. Those of ordinary skill in the art and others will recognize that system memory 1804 typically stores data and/or program modules that are immediately accessible to and/or currently being operated on by the processor 1802. In this regard, the processor 1802 may serve as a computational center of the computing device 1800 by supporting the execution of instructions.

As further illustrated in FIG. 18, the computing device 1800 may include a network interface 1810 comprising one or more components for communicating with other devices over a network. Embodiments of the present disclosure may access basic services that utilize the network interface 1810 to perform communications using common network protocols. The network interface 1810 may also include a wireless network interface configured to communicate via one or more wireless communication protocols, such as WiFi, 2G, 3G, 4G, LTE, WiMAX, Bluetooth, and/or the like.

In the illustrative embodiment depicted in FIG. 18, the computing device 1800 also includes a storage medium 1808. However, services may be accessed using a computing device that does not include means for persisting data to a local storage medium. Therefore, the storage medium 1808 depicted in FIG. 18 is optional. In any event, the storage medium 1808 may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like.

As used herein, the term “computer-readable medium” includes volatile and nonvolatile and removable and non-removable media implemented in any method or technology capable of storing information, such as computer-readable instructions, data structures, program modules, or other data. In this regard, the system memory 1804 and storage medium 1808 depicted in FIG. 18 are examples of computer-readable media.

For ease of illustration and because it is not important for an understanding of the claimed subject matter, FIG. 18 does not show some of the typical components of many computing devices. In this regard, the computing device 1800 may include input devices, such as a keyboard, keypad, mouse, trackball, microphone, video camera, touchpad, touchscreen, electronic pen, stylus, and/or the like. Such input devices may be coupled to the computing device 1800 by wired or wireless connections including RF, infrared, serial, parallel, Bluetooth, USB, or other suitable connection protocols using wireless or physical connections.

In any of the described examples, data can be captured by input devices and transmitted or stored for future processing. The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to the computing device 1800 (e.g., a client device), or can be integral components of the computing device 1800. In some embodiments, multiple input devices may be combined into a single, multifunction input device (e.g., a video camera with an integrated microphone). Any suitable input device either currently known or developed in the future may be used with systems described herein.

The computing device 1800 may also include output devices such as a display, speakers, printer, etc. The output devices may include video output devices such as a display or touchscreen. The output devices also may include audio output devices such as external speakers or earphones. The output devices can be separate from and communicatively coupled to the computing device 1800, or can be integral components of the computing device 1800. In some embodiments, multiple output devices may be combined into a single device (e.g., a display with built-in speakers). Further, some devices (e.g., touchscreens) may include both input and output functionality integrated into the same input/output device. Any suitable output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl, HTML, CSS, JavaScript, VBScript, ASPX, Microsoft .NET™ languages such as C#, and/or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

### III. Extensions and Alternatives

Although the examples herein are described in the context of UC service (e.g., voice or video service) deployments for ease of discussion, many of the features described herein can facilitate other activities that may relate to such deployments. For example, examples described herein allow detailed object transformation information (e.g., information describing changes in survey objects, design objects, or other objects) to be recorded in a database during a service deployment. This information is useful during the service deployment, but also may be useful in activities that follow the service deployment.

In one illustrative scenario, combinations of features described herein, such as the ability to capture object transformation information in a database, the ability to control workflows and provide related notifications, the ability to manage project-related communications (e.g., by analyzing structured text e-mails), and the ability to create detailed reports (e.g., via report templates for exporting project-related data) can provide a basis for activities such as financial integration and establishing audit trails. A security-relevant chronological record or set of records and/or information identifying the source of such records can provide documentary evidence of a sequence of activities that have affected a specific operation, procedure, or event associated with a service deployment. Such records and information can provide visibility to data supporting financial transactions, analysis/research, and communications by individual people, systems, accounts, or other entities relating to service deployments.

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

Many alternatives to the user interfaces described herein are possible. In practice, the user interfaces described herein may be implemented as separate user interfaces or as different states of the same user interface, and the different states can be presented in response to different events, e.g., user input events. The elements shown in the user interfaces can be modified, supplemented, or replaced with other elements in various possible implementations.

### IV. Illustrative Embodiments

Embodiments disclosed herein include:
A computer-implemented method for performing one or more of the above-described techniques.
A server computer comprising a processing unit and computer-readable storage media having stored thereon computer-executable instructions configured to cause the server computer to perform one or more of the above-described techniques.
A computer-readable storage medium having stored thereon computer-executable instructions configured to cause a computing device to perform one or more of the above-described techniques.
A computer system comprising a server that provides one or more of the above-described services. The computer system may further comprise client computing devices.
A client computing device in communication with a server that provides one or more of the above-described services, the client computing device comprising a processing unit and computer-readable storage media having stored thereon computer-executable instructions configured to cause the client computing device to perform one or more of the above-described techniques.

While illustrative embodiments have been illustrated and described, it will be appreciated that various changes can be made therein without departing from the spirit and scope of the claimed subject matter.

The embodiments of the invention in which an exclusive property or privilege is claimed are defined as follows:

1. A computer system comprising one or more processing units and computer-readable media having stored thereon computer-executable instructions configured to cause the computer system to:
create a plurality of objects with associated tasks to be executed in a voice or video service deployment; and
automatically control workflow associated with the tasks in the voice or video service deployment.

2. The computer system of claim 1, wherein the tasks comprise survey tasks that involve gathering at least one of the following types of information: country information, cabling information, site information, environment information, protocol information, network configuration information, private automatic branch exchange (PABX) system information.

3. The computer system of claim 2, wherein the tasks comprise design tasks that are based at least in part on information gathered via the survey tasks.

4. The computer system of claim 1, wherein the instructions are further configured to cause the computer system to automatically associate a message with at least one of the objects.

5. The computer system of claim 4, wherein the message comprises structured text.

6. The computer system of claim 4, wherein the message comprises a task identifier.

7. The computer system of claim 1, wherein the workflow is automatically controlled at least in part by a task management center.

8. The computer system of claim 1, wherein the instructions are further configured to cause the computer system to automatically generate a notification in response to a change in workflow status of at least one of the objects.

9. A computer-implemented invention comprising:
by a client computing device, presenting a user interface that provides access to an object having a workflow status in a voice or video service deployment; and
by the client computing device, receiving input via the user interface that effects a change in the workflow status and thereby causes generation of an automated notification message associated with the object.

10. The method of claim 9 further comprising, by the client computing device, presenting in the user interface a workflow diagram comprising workflow information for the object.

11. The method of claim 9, wherein the object is a survey object.

12. The method of claim 9, wherein the object is a design object.

13. The method of claim 9, wherein the automated notification message comprises an e-mail message.

14. The method of claim 9, wherein the automated notification message is directed to a responsible entity associated with the object.

15. The method of claim 9, wherein the automated notification message comprises a link to the object.

16. A computer system comprising one or more processing units and computer-readable media having stored thereon computer-executable instructions configured to cause the computer system to:
obtain and store object transformation information relating to a plurality of objects with associated tasks to be executed in a voice or video service deployment;
automatically control workflow associated with the tasks in the service deployment; and
automatically associate messages related to the service deployment with one or more of the objects.

17. The computer system of claim 16, wherein the instructions are further configured to cause the computer system to generate reports.

18. The computer system of claim 17, wherein the reports are based at least in part on the object transformation information.

19. The computer system of claim 16, wherein the instructions are further configured to cause the computer system to generate an audit trail.

20. The computer system of claim 19, wherein the audit trail is based at least in part on the object transformation information.
